(19) United States
(12) Patent Application Publication
(10) Pub. No.: US 2025/0189986 A1
(43) Pub. Date: Jun. 12, 2025

(54) METHOD FOR PARTITION CLEANING PLANNING OF CLEANING ROBOT, CLEANING ROBOT AND COMPUTER-READABLE STORAGE MEDIUM

(71) Applicant: Ubtech Robotics Corp Ltd., Shenzhen (CN)

(72) Inventors: XIANGBIN HUANG, Shenzhen (CN); Yanzhang Feng, Shenzhen (CN); Meng Li, Shenzhen (CN)

(21) Appl. No.: 18/961,521

(22) Filed: Nov. 27, 2024

(30) Foreign Application Priority Data
Dec. 9, 2023 (CN) 202311692623.5

(51) Int. Cl. G05D 1/648; A47L 1/02; A47L 9/28; A47L 11/40; G05D 1/644; G05D 105/10

(52) U.S. Cl. CPC G05D 1/6482; A47L 1/02; A47L 9/2852; A47L 11/4011; G05D 1/644; A47L 2201/04; G05D 2105/10

(57) ABSTRACT

A method for partition cleaning planning of a cleaning robot includes: obtaining a first position of the cleaning robot at a current cleaning moment, and a second position at a previous cleaning moment previous to the current cleaning moment; in response to a distance between the first position and the second position is greater than a predetermined distance threshold, determining a partition to which the first position of the cleaning robot belongs; determining an uncleaned area within the partition to which the first position belongs, and performing path planning based on the uncleaned area; and controlling the cleaning robot according to a result of the path planning.

### CROSS REFERENCE TO RELATED APPLICATIONS

This application claims priority to Chinese Patent Application No. CN 202311692623.5, filed Dec. 9, 2023, which is hereby incorporated by reference herein as if set forth in its entirety.

### TECHNICAL FIELD

The present disclosure generally relates to cleaning robots, and in particular relates to a method for partition cleaning planning of a cleaning robot, cleaning robot and computer-readable storage medium.

### BACKGROUND

When a cleaning robot performs cleaning tasks, it typically partitions the cleaning area to facilitate management and usage, prevent cross-contamination, and reduce the frequency of cleaning. By setting the boundaries of the partitions, the cleaning robot can plan its cleaning path according to the partitions.

However, during the operation of the cleaning robot, there may be situations where its position changes. For example, during the operation of the cleaning robot, it might be paused and moved to another location to continue cleaning. When the cleaning robot is in the new position, it usually cannot effectively plan its cleaning path based on the new location, which negatively impacts the user experience.

Therefore, there is a need to provide a method for partition cleaning planning of a cleaning robot to overcome the above-mentioned problems.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of a cleaning robot according to one embodiment.

FIG. 2 is an exemplary flowchart of a method for partition cleaning planning of a cleaning robot according to one embodiment.

FIG. 3 is a schematic diagram of a path of a cleaning record according to one embodiment.

FIG. 4 is a schematic diagram of the cleaning path after dilation.

FIG. 5 is a schematic diagram of an uncleaned area determined according to a cleaning record according to one embodiment.

FIG. 6 is an exemplary flowchart of a method for path planning for uncleaned areas according to one embodiment.

FIG. 7 is a schematic diagram of the process of creating partitions and cleaning according to one embodiment.

FIG. 8 is a schematic diagram of the process of creating partitions and cleaning according to one embodiment.

FIG. 9 is a schematic diagram of the process of creating partitions and cleaning according to one embodiment.

FIG. 10 is a schematic block diagram of device for partition cleaning planning of a cleaning robot according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

The present disclosure provides a method for a mobile robot that processes an initial map generated during a robot mapping process to obtain a target area-dividing map of a target area. In this way, the target area-dividing map of the work areas can be accurately obtained, and the task path can be reasonably planned based on the target area-dividing map, thereby improving operational efficiency of the mobile robot.

The mobile robot can be, but are not limited to, a cleaning robot (e.g., smart vacuum cleaner, smart robot mop, window cleaning robot), a companion mobile robot (e.g., smart electronic pet, nanny robot), a service mobile robot (e.g., reception robot for hotels, motels, and meeting venues), an industrial inspection smart device (e.g., power inspection robot, smart forklift), and a security robot (e.g., household or commercial smart security robot). These examples of robots are provided for illustration purposes only and do not constitute any limitations.

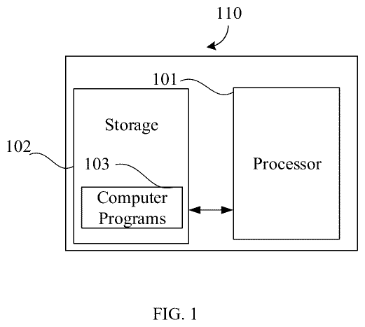

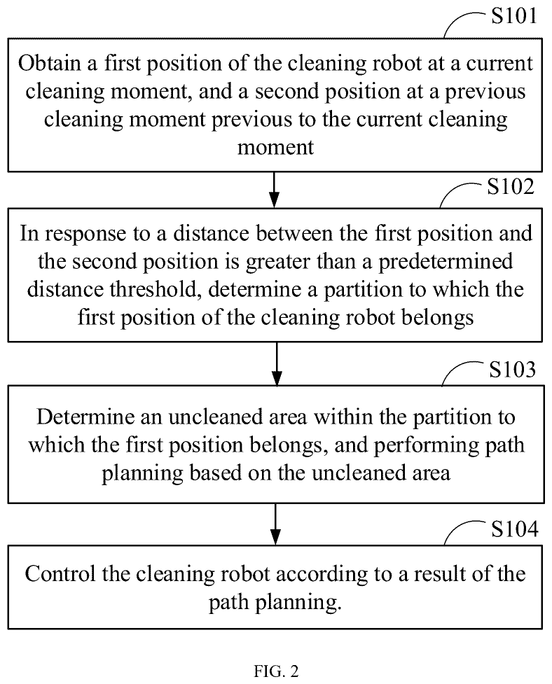

FIG. 1 shows a schematic block diagram of a cleaning robot 110 according to one embodiment. The robot 110 may include a processor 101, a storage 102, and one or more executable computer programs 103 that are stored in the storage 102. The storage 102 and the processor 101 are directly or indirectly electrically connected to each other to realize data transmission or interaction. For example, they can be electrically connected to each other through one or more communication buses or signal lines. The processor 101 performs corresponding operations by executing the executable computer programs 103 stored in the storage 102. When the processor 101 executes the computer programs 103, the steps in the embodiments of a method for partition cleaning planning of the cleaning robot 110, such as steps S101 to S104 in FIG. 2 are implemented.

The processor 101 may be an integrated circuit chip with signal processing capability. The processor 101 may be a central processing unit (CPU), a general-purpose processor, a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 101 can implement or execute the methods, steps, and logical blocks disclosed in the embodiments of the present disclosure.

The storage 102 may be, but not limited to, a random-access memory (RAM), a read only memory (ROM), a programmable read only memory (PROM), an erasable programmable read-only memory (EPROM), and an electrical erasable programmable read-only memory (EEPROM). The storage 102 may be an internal storage unit of the robot 110, such as a hard disk or a memory. The storage 102 may also be an external storage device of the robot 110, such as a plug-in hard disk, a smart memory card (SMC), and a secure digital (SD) card, or any suitable flash cards. Furthermore, the storage 102 may also include both an internal storage unit and an external storage device. The storage 102 is to store computer programs, other programs, and data required by the robot 110. The storage 102 can also be used to temporarily store data that have been output or is about to be output.

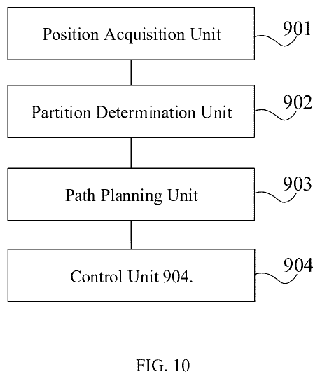

Exemplarily, the one or more computer programs 103 may be divided into one or more modules/units, and the one or more modules/units are stored in the storage 102 and executable by the processor 101. The one or more modules/units may be a series of computer program instruction segments capable of performing specific functions, and the instruction segments are used to describe the execution process of the one or more computer programs 103 in the robot 110. For example, the one or more computer programs 103 may be divided into a position acquisition unit 901, a partition determination unit 902, a path planning unit 903, and a control unit 904 as shown in FIG. 10.

It should be noted that the block diagram shown in FIG. 1 is only an example of the robot 110. The robot 110 may include more or fewer components than what is shown in FIG. 1, or have a different configuration than what is shown in FIG. 1. Each component shown in FIG. 1 may be implemented in hardware, software, or a combination thereof.

When a cleaning robot is performing a cleaning task, untypical situations may occur. For example, the cleaning robot may be moved by a user to a location that needs to be cleaned for cleaning, or the cleaning robot may be pushed to a new location for cleaning. Since the cleaning robot is in a new location, it cannot quickly and effectively plan the cleaning path in the new location. The user may need to manually set the cleaning path or follow the previous path, which can lead to missed areas or repeated cleaning, affecting the user experience.

In view of the foregoing, it would be desirable to provide a method for partition cleaning planning of a cleaning robot. FIG. 2 is an exemplary flowchart of a method for partition cleaning planning of a cleaning robot according to one embodiment. As an example, but not a limitation, the method can be implemented by the robot 110. The method may include the following steps.

Step S101: Obtain a first position of the cleaning robot at a current cleaning moment, and a second position at a previous cleaning moment previous to the current cleaning moment.

Here, a cleaning moment of the cleaning robot is a moment when the cleaning robot is in the state of performing the cleaning task. When the cleaning robot is in a working state but is moved off the cleaning surface (e.g., floor), since the cleaning robot is not performing the cleaning task on the floor, the time when the cleaning robot is moved off the ground is not a cleaning moment. In this case, the height between the cleaning robot and the floor can be detected, and the detected height can be compared with a predetermined height threshold. If the detected height is greater than the height threshold, it is determined that the cleaning robot is not at a cleaning moment.

When the cleaning robot is in a paused state, the position of the cleaning robot can be changed by pushing or dragging the cleaning robot. During the pushing or pulling process, the cleaning robot does not leave the floor. In this case, since the cleaning robot has been paused, the moment when the cleaning robot is detected to be in a pulling or pushing state in the paused state is not cleaning moment.

In a possible situation, the cleaning robot may be in working state and pulled or pushed by the user. In this case, the cleaning robot is in an untypical cleaning state. Therefore, it can be determined whether the cleaning robot is currently at a cleaning moment according to the current passive movement speed (i.e., the movement speed generated by the external force) of the cleaning robot. For example, when the passive movement speed of the cleaning robot is greater than a predetermined speed threshold which can be set to be greater than or equal to 0, it is determined that the moment is not a cleaning moment. If the passive movement speed of the cleaning robot (e.g., the passive movement speed is 0) is less than or equal to the speed threshold, and the cleaning robot is in working state, then the moment is a cleaning moment.

For example, when the cleaning robot is at position A, it begins to be pushed by a user, deviates from the original planned path 11, moves to position B at a passive moving speed v, stops moving and is in a working state (i.e., the cleaning robot is in a cleaning state), and position B can be determined as the first position. The time corresponding to position A when it is in a normal working state and not affected by external force is the previous cleaning moment, and position A is the second position

According to the above-mentioned approach, it can be determined whether the cleaning robot is in a cleaning moment at any time. When it is detected that the cleaning robot is in the cleaning moment at the current moment, the first position at the current moment is obtained. That is, the position of the cleaning robot corresponding to the current moment when the cleaning robot is in the cleaning state is determined as the first position. After the first position is determined, the second position corresponding to the previous moment when the cleaning robot was in the cleaning state before the current moment and closest to the current moment can be detected.

Step S102: In response to a distance between the first position and the second position is greater than a predetermined distance threshold, determine a partition to which the first position of the cleaning robot belongs.

After the first position of the cleaning robot at the current cleaning moment and the second position at the previous cleaning moment are determined, it can be determined whether an abnormal position change of the cleaning robot has occurred based on the distance between the first position and the second position.

If the distance between the first position and the second position is greater than the predetermined distance threshold, it indicates that the cleaning robot has undergone an abnormal position change between the current cleaning moment and the previous cleaning moment. If the distance between the first position and the second position is less than or equal to the predetermined distance threshold, it indicates that the cleaning robot has not undergone an abnormal position change between the current cleaning moment and the previous cleaning moment.

The distance threshold is related to the moving distance between two cleaning moments when the cleaning robot is working normally. For example, when the cleaning robot is working normally, the time between two cleaning moments is t1 seconds, and the distance travelled by the cleaning robot per second is v1, then the distance threshold can be set to be greater than or equal to v1*t1.

After is has determined that the cleaning robot has undergone an abnormal position change, it needs to re-plan the cleaning path of the cleaning robot. Before replanning the path, it can first determine the partition to which the cleaning robot currently belongs. If the current position does not belong to a pre-created partition, it can create the partition to which the cleaning robot belongs based on the location of the partition before the position change and the current position of the cleaning robot.

The partition of the cleaning robot can be created during the cleaning process. For example, when the cleaning robot is planning a closed path, if the cleaning robot is on the partition boundary of the partition, and the area outside the partition belongs to the area to be cleaned, and there is no partition in the area to be cleaned, then a new partition can be expanded based on the partition cleaned by the cleaning robot and the area to be cleaned.

Step S103: Determine an uncleaned area within the partition to which the first position belongs, and performing path planning based on the uncleaned area.

After the cleaning robot has an abnormal position change and the partition to which the cleaning robot belongs is determined, a search can be performed in the cleaning record in the first period before the current moment. The cleaned area in the partition where the cleaning robot is located is determined based on the cleaning record. The cleaned area in the partition can be removed to obtain the uncleaned area in the partition.

The first time period can be a time range determined by the current moment and the first moment before the current moment. A partition in the map is a range of a predetermined size set when cleaning the scene. The predetermined size can be the size of a square or the size of a rectangle. The cleaned areas and the uncleaned areas are states determined according to the cleaning record in the scene. In the same partition, the cleaned area(s) and the uncleaned area(s) can be included, or only the cleaned area(s) can be included, or only the uncleaned area(s) can be included.

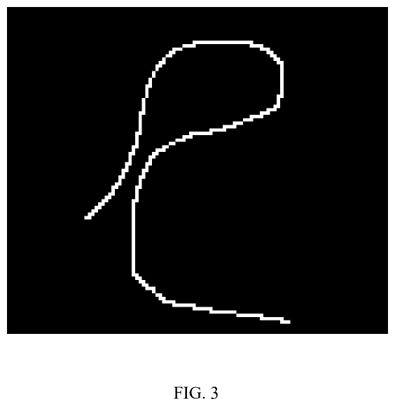

When determining the uncleaned area in the partition where the cleaning robot is located based on the cleaning record, it can first obtain the cleaning path corresponding to the cleaning record. As shown in FIG. 3, the white line in the figure is the cleaning path corresponding to the cleaning record of the cleaning surface in the first time period in the partition. That is, the cleaning record is close to the current moment and can be used to determine the cleaned area in the partition.

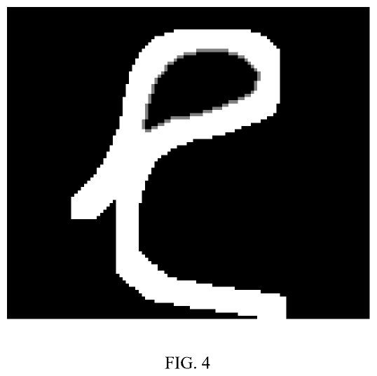

When determining the cleaned area according to the cleaning path in the cleaning record, it can perform dilation on the cleaning path according to a predetermined dilation radius. As shown in FIG. 4, after the dilation process, a white area in the figure can be obtained. The white area can be determined as the cleaned area of the partition.

The dilation radius may be determined according to the cleaning radius of the cleaning robot. For example, the dilation radius may be the same as the cleaning radius of the cleaning robot, or the dilation radius may be smaller than the cleaning radius of the cleaning robot. The dilation radius determined by the cleaning radius may accurately and effectively determine the cleaned area of the cleaning robot.

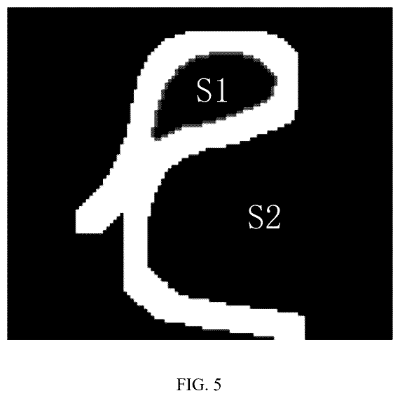

After the dilation process is completed, the uncleaned area included in the partition can be obtained (e.g., the black areas in FIG. 4). In order to effectively clean the uncleaned area in the partition, the uncleaned area can be divided into an isolated area and a non-isolated area. Among them, the isolated area is the area surrounded by the cleaned area. As shown in FIG. 5, the uncleaned area surrounded by the cleaned area is the isolated area S1, and the uncleaned area outside the cleaned area is the non-isolated area S2.

Step S104: Control the cleaning robot according to a result of the path planning.

Typically, a first cleaning path can be planned according to the non-isolated area, and a second cleaning path can be planned according to the isolated area. The cleaning task can be performed according to the first cleaning path first, and then according to the second cleaning path.

In one embodiment, a third position at an end of the first cleaning path and a fourth position at an end of the second cleaning path can be determined. The distances to the nearest uncleaned partition can be determined according to the third position and the fourth position, respectively. The order of the first cleaning path and the second cleaning path is determined according to the nearest distances. For example, if the distance from the third position to the nearest uncleaned partition is less than the distance from the fourth position to the nearest uncleaned partition, the cleaning task will be performed according to the second cleaning path first first, so that the cleaning robot can perform the cleaning work of the next partition more quickly.

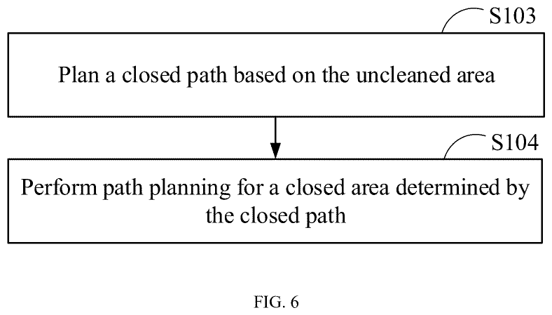

In one embodiment, as shown in FIG. 6, performing path planning based on the uncleaned area may include the following steps.

Step S501: Plan a closed path based on the uncleaned area.

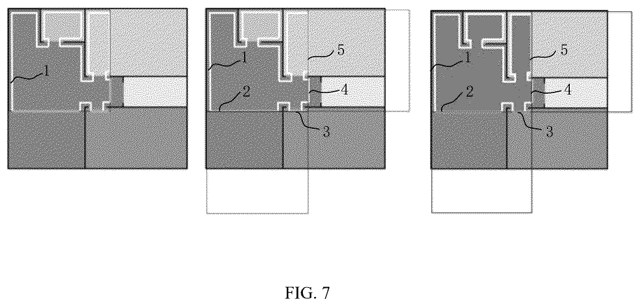

The closed path of the uncleaned area is a path including the outer contour of the uncleaned area. As shown in the left sub-figure of FIG. 7, the planned closed path (i.e., the white path in the left sub-figure of FIG. 7) of the uncleaned area can be determined according to the partition boundary of the partition where the cleaning robot is located and obstacles.

In the process of determining the white path (i.e., the closed path), if the planned path is located at the boundary of the partition and the area outside the partition is the area to be cleaned, a new partition can be created according to the size of the partition and the position of the area to be cleaned.

For example, as shown in the middle sub-figure of FIG. 7, when planning a closed path, when the planned closed path extends from point 1 to point 2, point 2 is at the partition boundary of the partition where the cleaning robot is currently located. The area outside the partition boundary is the area to be cleaned without a partition. Therefore, according to the size of the partition—where the partition in FIG. 7 is a square—the partition below the current partition can be created according to the side length of the square, as well as the position of the area to be cleaned or the position of the current planning point (i.e., point 2).

When the path extends to point 3, the planning point returns to the partition boundary. However, since a partition already exists outside the partition where the planning point is located, a new partition will not be created based on point 3.

When the path extends to point 4, point 4 is at the boundary of the partition, and the area outside the partition is the area to be cleaned. There is no partition outside the partition where the planning point is located, so a new partition can be created. That is, a partition will be created on the right side of the partition where the cleaning robot is currently located.

When the path extends to point 5, the planning point returns to the partition boundary. However, since a partition already exists outside the partition where the planning point is located, a new partition will not be created based on point 5.

Step S502: Perform path planning for a closed area determined by the closed path.

After creating a closed path, path planning can be further performed in the closed partition determined by the closed path to clean the area within the closed area. As shown in the right sub-figure in FIG. 7, after the area within the closed area is cleaned, it can be filled with a preset color or lines.

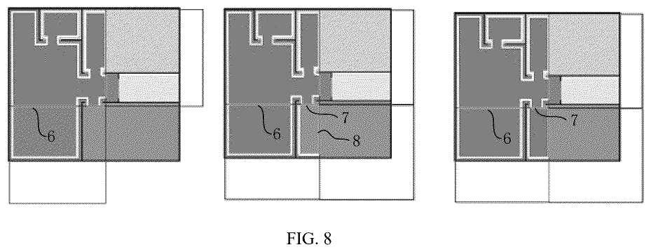

After completing the cleaning of the first partition, the uncleaned area in the created partition can be cleaned according to the partition created when the closed path was created previously. As shown in FIG. 8, when cleaning the lower partition, a closed path of the area to be cleaned can be created first, including a closed path planned from point 6 and a closed path planned from point 7. When the closed path planned from point 7 is extended to point 8, since the planned point is at the boundary of the partition, the area outside the boundary of the partition is an uncleaned area without a partition, the partition in the lower right corner can be created as shown in the middle sub-figure of FIG. 8. After performing cleaning according to the closed path and filling the cleaned areas, and right sub-figure of FIG. 8 can be obtained.

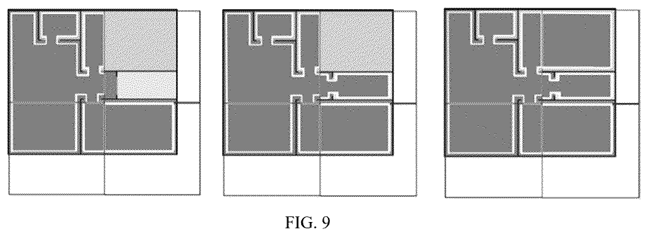

After completing the cleaning of the lower left partition, the path planning and cleaning of the lower right partition can be performed according to the principle of proximity. As shown in FIG. 9, a closed path of the uncleaned area of the partition in the lower right corner can be created first, and the cleaning planning can be performed according to the closed path. After the cleaning is completed, the left sub-figure of FIG. 9 filled with colors or lines can be obtained. As shown in the middle sub-figure of FIG. 9, the closed path (including two closed paths) of the partition in the upper right corner can be determined in the same manner, and the cleaning can be performed according to the determined closed path, and the middle and right sub-figures of FIG. 8 can be obtained respectively.

It should be understood that sequence numbers of the foregoing processes do not mean an execution sequence in the above-mentioned embodiments. The execution sequence of the processes should be determined according to functions and internal logic of the processes, and should not be construed as any limitation on the implementation processes of the above-mentioned embodiments.

FIG. 10 is a schematic block diagram of a device for partition cleaning planning of a cleaning robot according to one embodiment. In one embodiment, the device may include a position acquisition unit 901, a partition determination unit 902, a path planning unit 903, and a control unit 904. The position acquisition unit 901 is to obtain a first position of the cleaning robot at a current cleaning moment, and a second position at a previous cleaning moment previous to the current cleaning moment. The partition determination unit 902 is to, in response to a distance between the first position and the second position is greater than a predetermined distance threshold, determine a partition to which the first position of the cleaning robot belongs. The path planning unit 903 is to determine an uncleaned area within the partition to which the first position belongs, and performing path planning based on the uncleaned area. The control unit 904 is to control the cleaning robot according to a result of the path planning.

Each unit in the device discussed above may be a software program module, or may be implemented by different logic circuits integrated in a processor or independent physical components connected to a processor, or may be implemented by multiple distributed processors.

It should be noted that content such as information exchange between the modules/units and the execution processes thereof is based on the same idea as the method embodiments of the present disclosure, and produces the same technical effects as the method embodiments of the present disclosure. For the specific content, refer to the foregoing description in the method embodiments of the present disclosure. Details are not described herein again.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for partition cleaning planning of a cleaning robot, the method comprising:
obtaining a first position of the cleaning robot at a current cleaning moment, and a second position at a previous cleaning moment previous to the current cleaning moment;
in response to a distance between the first position and the second position is greater than a predetermined distance threshold, determining a partition to which the first position of the cleaning robot belongs;
determining an uncleaned area within the partition to which the first position belongs, and performing path planning based on the uncleaned area; and
controlling the cleaning robot according to a result of the path planning.

2. The method of claim 1, wherein determining the uncleaned area within the partition to which the first position belongs comprises:
obtaining a cleaning path in a cleaning record for the partition to which the first position belongs; and
performing dilation on the cleaning path based on a predetermined dilation radius to obtain a cleaned area in the partition, and determining the uncleaned area in the partition based on the cleaned area.

3. The method of claim 2, wherein performing path planning based on the uncleaned area comprises:
determining an unisolated area and an isolated area in the uncleaned area in the partition, wherein the isolated area is an area surrounded by the cleaned area, and the unisolated area is an area not surrounded by the cleaned area;
planning a first cleaning path in the unisolated area, and planning a second cleaning path in the isolated area; and
performing path planning on the uncleaned area according to the first cleaning path and the second cleaning path.

4. The method of claim 3, further comprising, after performing path planning on the uncleaned area according to the first cleaning path and the second cleaning path,
determining a third position of an end of the first cleaning path and a fourth position of an end of the second cleaning path; and
determining a cleaning order for the first cleaning path and the second cleaning path according to a distance from the third position to the uncleaned area and a distance from the fourth position to the uncleaned area.

5. The method of claim 1, wherein obtaining the first position of the cleaning robot at the current cleaning moment, and the second position at the previous cleaning moment previous to the current cleaning moment comprises:
in response to detection of the cleaning robot being currently in a state of cleaning a floor, determining a current moment as the current cleaning moment, and determining a current position of the cleaning robot as the first position; and
obtaining, before the current moment, a previous adjacent moment when the cleaning robot was detected to start to be in a state of cleaning the floor, and determining a position of the cleaning robot at the moment as the second position.

6. The method of claim 1, wherein performing path planning based on the uncleaned area comprises:
planning a closed path based on the uncleaned area; and
performing path planning for a closed area determined by the closed path.

7. The method of claim 6, wherein planning the closed path based on the uncleaned area comprises:
during a closed path planning process, in response to a planning point being on a partition boundary, an area outside a partition where the planning point is located being an area to be cleaned, and no partition existing in the area to be cleaned, expanding a new partition according to a partition size and the area to be cleaned.

8. A cleaning robot comprising:
one or more processors; and
a memory coupled to the one or more processors, the memory storing programs that, when executed by the one or more processors, cause performance of operations comprising:
obtaining a first position of the cleaning robot at a current cleaning moment, and a second position at a previous cleaning moment previous to the current cleaning moment;
in response to a distance between the first position and the second position is greater than a predetermined distance threshold, determining a partition to which the first position of the cleaning robot belongs;
determining an uncleaned area within the partition to which the first position belongs, and performing path planning based on the uncleaned area; and
controlling the cleaning robot according to a result of the path planning.

9. The cleaning robot of claim 8, wherein determining the uncleaned area within the partition to which the first position belongs comprises:
obtaining a cleaning path in a cleaning record for the partition to which the first position belongs; and
performing dilation on the cleaning path based on a predetermined dilation radius to obtain a cleaned area in the partition, and determining the uncleaned area in the partition based on the cleaned area.

10. The cleaning robot of claim 9, wherein performing path planning based on the uncleaned area comprises:
determining an unisolated area and an isolated area in the uncleaned area in the partition, wherein the isolated area is an area surrounded by the cleaned area, and the unisolated area is an area not surrounded by the cleaned area;
cleaning a first cleaning path in the unisolated area, and planning a second cleaning path in the isolated area; and
performing path planning on the uncleaned area according to the first cleaning path and the second cleaning path.

11. The cleaning robot of claim 10, wherein the operations further comprise, after performing path planning on the uncleaned area according to the first cleaning path and the second cleaning path,
determining a third position of an end of the first cleaning path and a fourth position of an end of the second cleaning path; and
determining a cleaning order for the first cleaning path and the second cleaning path according to a distance from the third position to the uncleaned area and a distance from the fourth position to the uncleaned area.

12. The cleaning robot of claim 8, wherein obtaining the first position of the cleaning robot at the current cleaning moment, and the second position at the previous cleaning moment previous to the current cleaning moment comprises:
in response to detection of the cleaning robot being currently in a state of cleaning a floor, determining a current moment as the current cleaning moment, and determining a current position of the cleaning robot as the first position; and
obtaining, before the current moment, a previous adjacent moment when the cleaning robot was detected to start to be in a state of cleaning the floor, and determining a position of the cleaning robot at the moment as the second position.

13. The cleaning robot of claim 8, wherein performing path planning based on the uncleaned area comprises:
planning a closed path based on the uncleaned area; and
performing path planning for a closed area determined by the closed path.

14. The cleaning robot of claim 13, wherein planning the closed path based on the uncleaned area comprises:
during a closed path planning process, in response to a planning point being on a partition boundary, an area outside a partition where the planning point is located being an area to be cleaned, and no partition existing in the area to be cleaned, expanding a new partition according to a partition size and the area to be cleaned.

15. A non-transitory computer-readable storage medium storing instructions that, when executed by at least one processor of a cleaning robot, cause the at least one processor to perform a method, the method comprising:
obtaining a first position of the cleaning robot at a current cleaning moment, and a second position at a previous cleaning moment previous to the current cleaning moment;
in response to a distance between the first position and the second position is greater than a predetermined distance threshold, determining a partition to which the first position of the cleaning robot belongs;
determining an uncleaned area within the partition to which the first position belongs, and performing path planning based on the uncleaned area; and
controlling the cleaning robot according to a result of the path planning.

16. The non-transitory computer-readable storage medium of claim 15, wherein determining the uncleaned area within the partition to which the first position belongs comprises:
obtaining a cleaning path in a cleaning record for the partition to which the first position belongs; and
performing dilation on the cleaning path based on a predetermined dilation radius to obtain a cleaned area in the partition, and determining the uncleaned area in the partition based on the cleaned area.

17. The non-transitory computer-readable storage medium of claim 16, wherein performing path planning based on the uncleaned area comprises:
determining an unisolated area and an isolated area in the uncleaned area in the partition, wherein the isolated area is an area surrounded by the cleaned area, and the unisolated area is an area not surrounded by the cleaned area;
cleaning a first cleaning path in the unisolated area, and planning a second cleaning path in the isolated area; and
performing path planning on the uncleaned area according to the first cleaning path and the second cleaning path.

18. The non-transitory computer-readable storage medium of claim 17, further comprising, after performing path planning on the uncleaned area according to the first cleaning path and the second cleaning path,
determining a third position of an end of the first cleaning path and a fourth position of an end of the second cleaning path; and
determining a cleaning order for the first cleaning path and the second cleaning path according to a distance from the third position to the uncleaned area and a distance from the fourth position to the uncleaned area.

19. The non-transitory computer-readable storage medium of claim 15, wherein obtaining the first position of the cleaning robot at the current cleaning moment, and the second position at the previous cleaning moment previous to the current cleaning moment comprises:
in response to detection of the cleaning robot being currently in a state of cleaning a floor, determining a current moment as the current cleaning moment, and determining a current position of the cleaning robot as the first position; and
obtaining, before the current moment, a previous adjacent moment when the cleaning robot was detected to start to be in a state of cleaning the floor, and determining a position of the cleaning robot at the moment as the second position.

20. The non-transitory computer-readable storage medium of claim 15, wherein performing path planning based on the uncleaned area comprises:
planning a closed path based on the uncleaned area; and
performing path planning for a closed area determined by the closed path.
